(19) United States
(12) Patent Application Publication
(10) Pub. No.: US 2015/0352393 A1
(43) Pub. Date: Dec. 10, 2015

(54) Water Game Assembly

(71) Applicant: Jose Benitez, Fort Myers, FL (US)

(72) Inventor: Jose Benitez, Fort Myers, FL (US)

(21) Appl. No.: 14/295,446

(22) Filed: Jun. 4, 2014

(51) Int. Cl. A63B 5/22; B05B 15/06

(52) U.S. Cl. CPC A63B 5/22; B05B 15/06

(57) ABSTRACT

A water game assembly for allowing a user to play the game of hopscotch in a sprinkler includes a mat that may be positioned on a support surface. The mat has indicia printed thereon in the convention of the game of hopscotch. A sprinkler is coupled to the mat. The sprinkler is coupled to a fluid source. The sprinkler delivers the fluid onto the mat. A user plays the game of hopscotch on the mat while the sprinkler delivers the fluid onto the mat.

### BACKGROUND OF THE DISCLOSURE

### Field of the Disclosure

The disclosure relates to game devices and more particularly pertains to a new game device for allowing a user to play the game of hopscotch in a sprinkler.

### SUMMARY OF THE DISCLOSURE

An embodiment of the disclosure meets the needs presented above by generally comprising a mat that may be positioned on a support surface. The mat has indicia printed thereon in the convention of the game of hopscotch. A sprinkler is coupled to the mat. The sprinkler is coupled to a fluid source. The sprinkler delivers the fluid onto the mat. A user plays the game of hopscotch on the mat while the sprinkler delivers the fluid onto the mat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top view of a water game assembly according to an embodiment of the disclosure.

FIG. 2 is a back view of an embodiment of the disclosure.

FIG. 3 is a perspective view of an embodiment of the disclosure.

FIG. 4 is an in-use view of an embodiment of the disclosure.

### DESCRIPTION OF THE PREFERRED EMBODIMENT

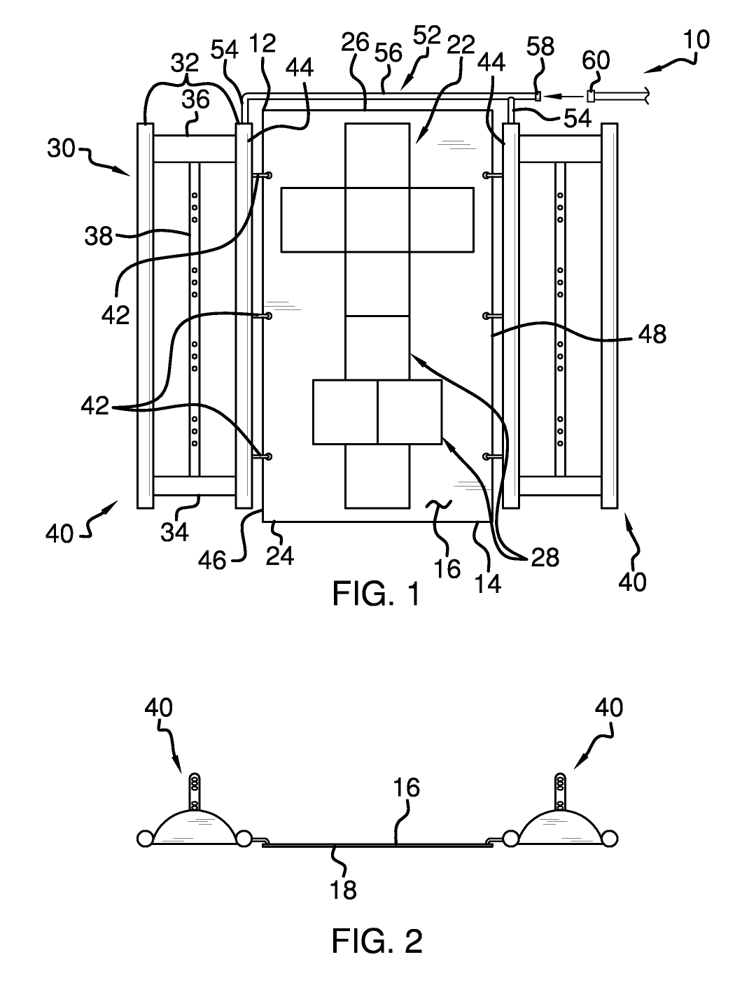

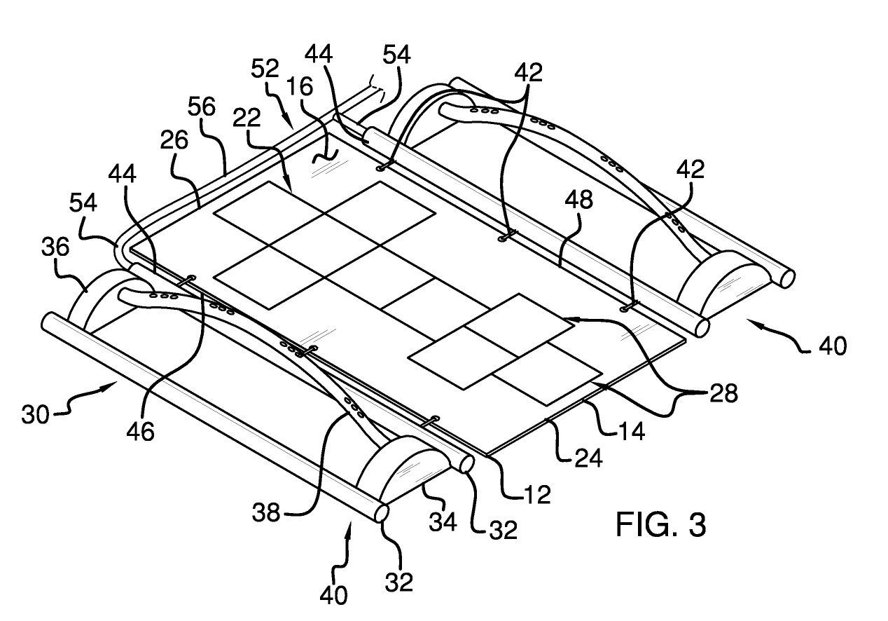

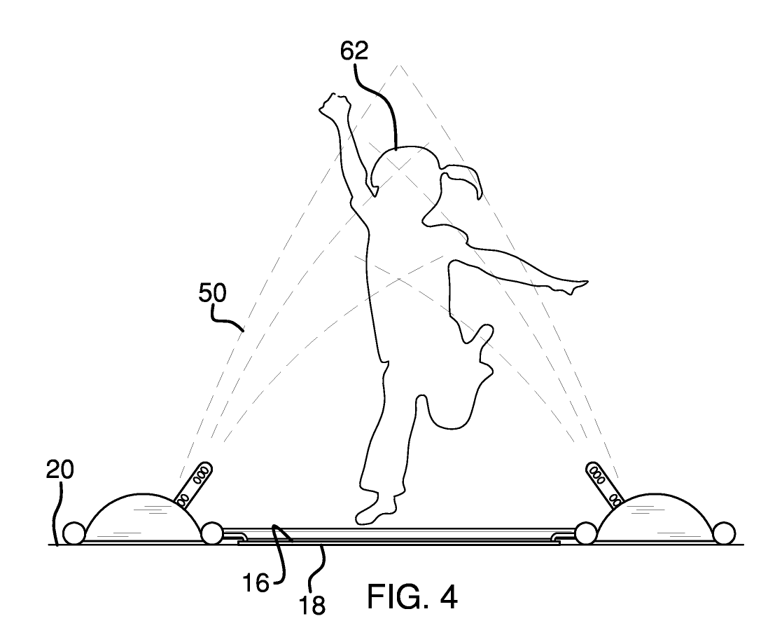

With reference now to the drawings, and in particular to FIGS. 1 through 4 thereof, a new game device embodying the principles and concepts of an embodiment of the disclosure and generally designated by the reference numeral 10 will be described.

As best illustrated in FIGS. 1 through 4, the water game assembly 10 generally comprises a mat 12 that has an outer edge 14 extending between a top surface 16 and a bottom surface 18 of the mat 12. The mat 12 is elongated. Additionally, the mat 12 is positionable on a support surface 20. The bottom surface 18 of the mat 12 abuts the support surface 20. The support surface 20 may be ground.

The mat 12 has indicia 22 printed on the top surface 16 of the mat 12. The indicia 22 extend between a front side 24 and a back side 26 of the outer edge 14 of the mat 12. The indicia 22 comprise a plurality of squares 28. The plurality of squares 28 are arranged in the convention of the game of hopscotch.

A sprinkler 30 is provided. The sprinkler 30 has a pair of rails 32 extending between each of a first end 34 and a second end 36 of the sprinkler 30. Additionally, the sprinkler 30 has a spray bar 38 extending between each of the first 34 and second 36 ends of the sprinkler 30. The spray bar 38 is positioned between the pair of rails 32. The sprinkler 30 may be a an oscillating sprinkler of any conventional design.

The sprinkler 30 is one of a pair of the sprinklers 40. A plurality of couplers 42 is coupled between an innermost one 44 of the pair of rails 32 of each of the pair of sprinklers 40 and an associated one of a first lateral side 46 and a second lateral side 48 of the outer edge 14 of the mat 12. The plurality of couplers 42 are evenly spaced apart and distributed between the first 34 and second 36 ends of the sprinkler 30. Each of the pair of sprinklers 40 are spaced apart from the associated one of the first 46 and second 48 lateral sides of the outer edge 14 of the mat 12. Each of the pair of sprinklers 40 is movably coupled to the mat 12. The pair of sprinklers 40 is each coextensive with the associated first 46 and second 48 lateral sides of the outer edge 14 of the mat 12. Additionally, each of the pair of sprinklers 40 delivers a fluid 50 onto the top surface 16 of the mat 12.

A fluid hose 52 is provided. The fluid hose 52 has a pair of sprinkler portions 54 of the fluid hose 52 extending laterally away from a delivery portion 56 of the fluid hose 52. Each of the pair of sprinkler portions 54 of the fluid hose 52 are spaced apart on the delivery portion 56 of the fluid hose 52. The pair of sprinkler portions 54 of the fluid hose 52 are each fluidly coupled to an associated one of the pair of sprinklers 40. A free end 58 of the delivery portion 56 of the fluid hose 52 is fluidly coupled to a fluid source 60.

The fluid source 60 may be a garden hose of any conventional design. The fluid hose 52 delivers the fluid 50 to each of the pair of sprinklers 40. Additionally, the fluid 50 may be water. A user 62 plays the game of hopscotch on the mat 12 while the pair of sprinklers 40 delivers the fluid 50 onto the top surface 16 of the mat 12. The user 62 may be a child.

In use, the mat 12 is positioned in an area for the user 62 to play the game of hopscotch. The fluid source 60 is fluidly coupled to the fluid hose 52. The user 62 plays the game of hopscotch while the fluid 50 is sprayed on the user 62 and the mat 12. The assembly 10 allows the user 62 to remain cool in a hot environment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A water game assembly configured to allow a user to play the game of hopscotch in a sprinkler, said assembly comprising:
a mat configured to be positioned on a support surface, said mat having indicia printed thereon in the convention of the game of hopscotch; and
a sprinkler coupled to said mat, said sprinkler being coupled to a fluid source such that said sprinkler delivers the fluid onto said mat.

2. The assembly according to claim 1, further comprising said mat having an outer edge extending between a top surface and a bottom surface of said mat, said mat being elongated.

3. The assembly according to claim 1, further comprising said mat being positionable on the support surface such that a bottom surface of said mat abuts the support surface.

4. The assembly according to claim 1, further comprising said sprinkler having a pair of rails extending between each of a first end and a second end of said sprinkler.

5. The assembly according to claim 1, further comprising said sprinkler having a spray bar extending between each of a first end and a second end of said sprinkler such that said spray bar is positioned between a pair of rails.

6. The assembly according to claim 1, further comprising said sprinkler being one of a pair of said sprinklers.

7. The assembly according to claim 6, further comprising an innermost one of a pair of rails of each of said pair of sprinklers being movably coupled to an associated one of a first lateral side and a second lateral side of an outer edge of said mat such that each of said pair of sprinklers is coextensive with said associated first and second lateral sides of said outer edge of said mat.

8. The assembly according to claim 1, further comprising each of said pair of sprinklers delivering the fluid onto a top surface of said mat.

9. The assembly according to claim 1, further comprising said indicia being printed on a top surface of said mat.

10. The assembly according to claim 1, further comprising said indicia extending between a front side and a back side of an outer edge of said mat.

11. The assembly according to claim 1, further comprising a fluid hose being fluidly coupled to each of said pair of sprinklers.

12. The assembly according to claim 1, further comprising a free end of a fluid hose being fluidly coupled to a fluid source such that said fluid hose delivers the fluid to each of said pair of sprinklers.

13. A water game assembly configured to allow a user to play the game of hopscotch in a sprinkler, said assembly comprising:
a mat having an outer edge extending between a top surface and a bottom surface of said mat, said mat being elongated, said mat being positionable on a support surface such that said bottom surface of said mat abuts the support surface;
said mat having indicia printed on a top surface of said mat in the convention of the game of hopscotch, said indicia extending between a front side and a back side of said outer edge of said mat;
a sprinkler having a pair of rails extending between each of a first end and a second end of said sprinkler, said sprinkler having a spray bar extending between each of said first and second ends of said sprinkler such that said spray bar is positioned between said pair of rails;
said sprinkler being one of a pair of said sprinklers;
an innermost one of said pair of rails of each of said pair of sprinklers being movably coupled to an associated one of a first lateral side and a second lateral side of said outer edge of said mat such that each of said pair of sprinklers is coextensive with said associated first and second lateral sides of said outer edge of said mat, each of said pair of sprinklers delivering a fluid onto said top surface of said mat; and
a fluid hose fluidly coupled to each of said pair of sprinklers, a free end of said fluid hose being fluidly coupled to a fluid source such that said fluid hose delivers the fluid to each of said pair of sprinklers.
